(19) United States
(12) Patent Application Publication
(10) Pub. No.: US 2026/0348862 A1
(43) Pub. Date: Nov. 5, 2026

(54) TEAR INSPECTION SYSTEM, APPARATUS, AND METHODS

(71) Applicant: Georgia-Pacific Gypsum LLC, Atlanta, GA (US)

(72) Inventors: Ahmed M. Buhamed, Al Hasa (SA); Jamie P. Honchar, Valparaiso, IN (US); Stephen M. Schroeder, Evans, GA (US)

(21) Appl. No.: 19/117,971

(22) PCT Filed: Sep. 18, 2023
(86) PCT No.: PCT/IB2023/059226

§ 371 Date: Apr. 3, 2025

Related U.S. Application Data
(60) Provisional application No. 63/416,617, filed on Oct. 17, 2022.

(51) Int. Cl. G01N 21/88; G06T 7/00; H04N 23/56

(52) U.S. Cl. CPC G01N 21/8806; G06T 7/001; H04N 23/56; G06T 2207/30108

(57) ABSTRACT

Systems, methods, apparatuses, computing devices, and/or the like are provided. In some embodiments, a method for detecting product tears is provided. In some embodiments, the method includes aligning, by a robotic device, an imaging device and a lighting device with a forming plate on a production line. In some embodiments, the method includes capturing, by the imaging device, one or more images of a product formed by the forming plate on the production line. In some embodiments, the method includes transmitting, to a control device, the one or more images of the product on the production line. In some embodiments, the method includes analyzing, by the control device, the one or more images of the product on the production line to determine if one or more tears have occurred. In some embodiments, the method includes, if a tear has occurred, signaling, by the control device, to halt the production line.

### CROSS-REFERENCE TO RELATED APPLICATIONS

This application claims the benefit of U.S. Provisional Application No. 63/416,617, filed Oct. 17, 2022 and entitled “TEAR INSPECTION SYSTEM, APPARATUS, AND METHODS,” which is incorporated by reference herein in its entirety

### TECHNICAL FIELD

The present disclosure relates generally to materials manufacturing, and more particularly to detecting tears and undesirable abrasions created during the manufacturing of gypsum.

### BACKGROUND

During gypsum manufacturing (and material manufacturing broadly), tears in the product may be caused by foreign objects lodging between the forming plate and paper. More generally, in production processes, foreign objects lodging between the production line and the product may lead to tears in the product. While some tears may resolve themselves (“self-heal”), others may grow in size and stall the production process. Stalled production may result in delays and unnecessary, time-consuming cleanup. In gypsum production specifically, a stall in production means paper must be re-threaded in the machine and slurry must be cleaned up. Further, each delay in production requires a corresponding restart to the production process, and each startup process may generate its own waste.

Tears in gypsum products may be detected by calibrating a conductivity rod and placing the rod between the running board line to detect an increase in moisture. A tear results in moisture seeping through the tear and triggering the calibration rod, signaling to technicians that there may have been a tear. However, the rod may be difficult to calibrate, particularly if a production line is being used to create a variety of products. A need exists for a more reliable tear detection system, both for gypsum manufacturing and for production lines more generally.

Through applied effort, ingenuity, and innovation, Applicant has solved problems relating to tear detection systems and apparatuses used in gypsum manufacturing by developing solutions embodied in the present disclosure, which are described in detail below.

### BRIEF SUMMARY

In general, various embodiments of the present disclosure provide methods, apparatuses, systems, computing devices, computing entities, and/or the like.

In accordance with various embodiments of the present disclosure, a system for detecting product tears is provided. In some embodiments, the system may include a lighting device configured to illuminate a portion of a product as it is produced by a forming device on a production line. In some embodiments, the system may include an imaging device configured to capture one or more images of the illuminated portion of the product as it is produced by the forming device on the production line. In some embodiments, the system may include a control device configured to store one or more thresholds. In some embodiments, the control device may be configured to receive the one or more captured images. In some embodiments, the control device may be configured to analyze the one or more captured images and, if at least a portion of one of the one or more captured images exceeds the one or more stored thresholds, send a signal to cease production on the production line.

In some embodiments, the lighting device and the imaging device may be aligned such that the one or more images illuminated and captured by the lighting device and the imaging device, respectively, are of the product as it exits the forming device on the production line.

In some embodiments, system may include a connecting component, the connecting component being operably connected to one or more of the lighting device and the imaging device, wherein the connecting component is configured to align the lighting device with the imaging device.

In some embodiments, system may include a robotic device configured to be operably connected to one or more of the lighting device and the imaging device and to position the one or more of the lighting device and the imaging device adjacent to the production line.

In some embodiments, the robotic device may be configured to position the one or more of the lighting device and the imaging device above the production line.

In some embodiments, the robotic device may be configured to align the lighting device and the imaging device.

In some embodiments, system may include a gantry configured to be operably connected to one or more of the lighting device and the imaging device and to position the one or more of the lighting device and the imaging device above the production line.

In some embodiments, the gantry may be operably connected to a rig disposed above the production line, and wherein the gantry is configured to slide along the rig and thereby reposition the gantry and the one or more of the lighting device and the imaging device above the production line.

In some embodiments, the portion of the object that is illuminated by the lighting device includes a width between 24 and 54 inches and a length between half an inch and four inches.

In some embodiments, the control device may be configured to analyze the one or more captured images and, if at least three of the one or more captured images exceed the one or more stored thresholds, send a signal to cease production on the production line.

In some embodiments, the one or more thresholds are selected from a group consisting of the color of the image, the width of the image, and the length of the image.

In some embodiments, the product is one or more gypsum boards.

In some embodiments, the lighting device is a line light.

In some embodiments, the imaging device is configured to capture at a speed of less than 100 milliseconds the one or more images of the illuminated portion of the product as it is produced by the forming device on the production line.

In some embodiments, the one or more captured images are grayscale at least when they are analyzed by the control device.

In some embodiments, the portion of the one of the one or more captured images is a tear in the product.

In some embodiments, the portion of the one of the one or more captured images is a defect that will self-heal.

In some embodiments, the control device is configured to refrain from sending a signal to cease production on the line if the one or more thresholds are not exceeded.

According to some embodiments, a method for detecting product tears is provided. In some embodiments, the method includes aligning, by a robotic device, an imaging device and a lighting device with a forming plate on a production line. In some embodiments, the method includes capturing, by the imaging device, one or more images of a product formed by the forming plate on the production line. In some embodiments, the method includes transmitting, to a control device, the one or more images of the product on the production line. In some embodiments, the method includes analyzing, by the control device, the one or more images of the product on the production line to determine if one or more tears have occurred. In some embodiments, the method includes, if a tear has occurred, signaling, by the control device, to halt the production line.

In some embodiments, the method includes, if a tear has not occurred, refraining, by the control device, from signaling to halt the production line.

The above summary is provided merely for purposes of summarizing some example various embodiments to provide a basic understanding of some embodiments of the disclosure. Accordingly, it will be appreciated that the above-described various embodiments are merely examples. It will be appreciated that the scope of the disclosure encompasses many potential various embodiments in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is diagram illustrating example architecture for an example control device in accordance with various embodiments of the present disclosure;

FIG. 2 is a schematic of an example management computing entity for an example control device in accordance with various embodiments of the present disclosure;

FIG. 3 is a schematic of an example user computing entity for an example control device in accordance with various embodiments of the present disclosure;

FIG. 4 is an angled view of an example system with a robotic device in accordance with various embodiments of the present disclosure;

FIG. 5 is an angled view of an example system with a robotic device in accordance with various embodiments of the present disclosure;

FIG. 6A is an angled view of an example system with a gantry in accordance with various embodiments of the present disclosure;

FIG. 6B is an angled view of an example system with a gantry in accordance with various embodiments of the present disclosure;

FIG. 7 illustrates example images taken by the example system in accordance with various embodiments of the present disclosure; and

FIG. 8 is a flow chart illustrating an example method of making using an example automated edge forming system in accordance with various embodiments of the present disclosure.

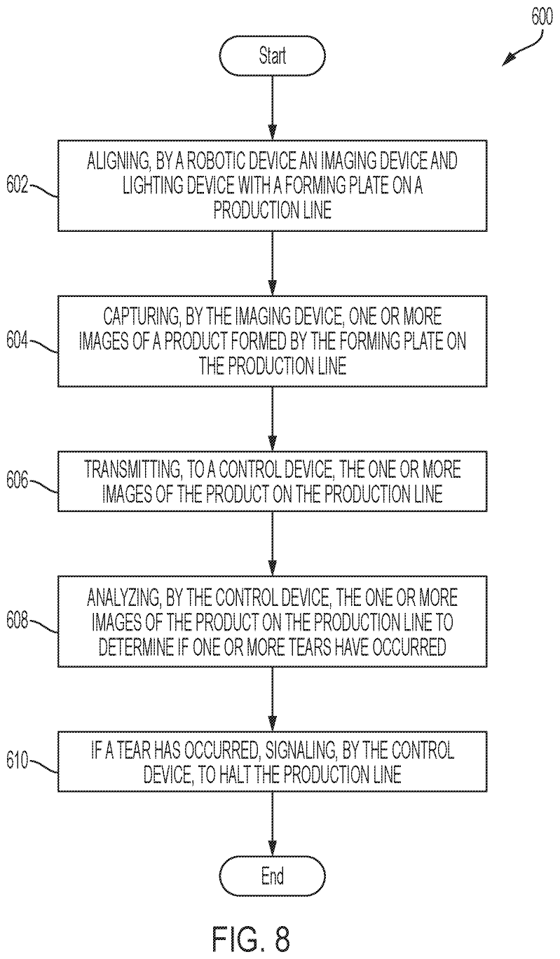

### DETAILED DESCRIPTION OF SOME EXAMPLE VARIOUS EMBODIMENTS

Various embodiments of the present disclosure now will be described more fully hereinafter with reference to the accompanying drawings, in which some, but not all various embodiments of the disclosure are shown. Indeed, this disclosure may be embodied in many different forms and should not be construed as limited to the various embodiments set forth herein; rather, these various embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

Various embodiments of the present disclosure may be implemented as computer program products that comprise articles of manufacture. Such computer program products may include one or more software components including, for example, applications, software objects, methods, data structures, and/or the like. A software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution.

As should be appreciated, various embodiments of the present disclosure may also be implemented as methods, apparatuses, systems, computing devices, computing entities, and/or the like. As such, various embodiments of the present disclosure may take the form of a data structure, apparatus, system, computing device, computing entity, and/or the like executing instructions stored on a computer-readable storage medium to perform certain steps or operations. Thus, various embodiments of the present disclosure may also take the form of an entirely hardware embodiment, an entirely computer program product embodiment, and/or an embodiment that comprises combination of computer program products and hardware performing certain steps or operations.

Various embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary various embodiments, retrieval, loading, and/or execution may be performed in parallel such that multiple instructions are retrieved, loaded, and/or executed together. Thus, such various embodiments can produce specifically-configured machines performing the steps or operations specified in the block diagrams and flowchart illustrations. Accordingly, the block diagrams and flowchart illustrations support various combinations of various embodiments for performing the specified instructions, operations, or steps.

### Computer Program Products, Systems, Methods, and Computing Entities

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially, such that one instruction is retrieved, loaded, and executed at a time. In some exemplary embodiments, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

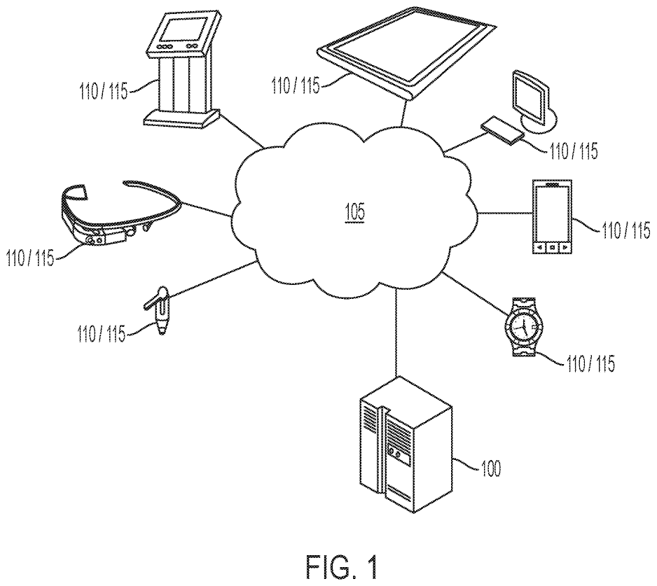

FIG. 1 provides an illustration of an exemplary system architecture that may be used in accordance with various embodiments of the present disclosure. As shown in FIG. 1, the architecture may include one or more management computing entities 100, one or more networks 105, and one or more user computing entities 110. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### Exemplary Management Computing Entity

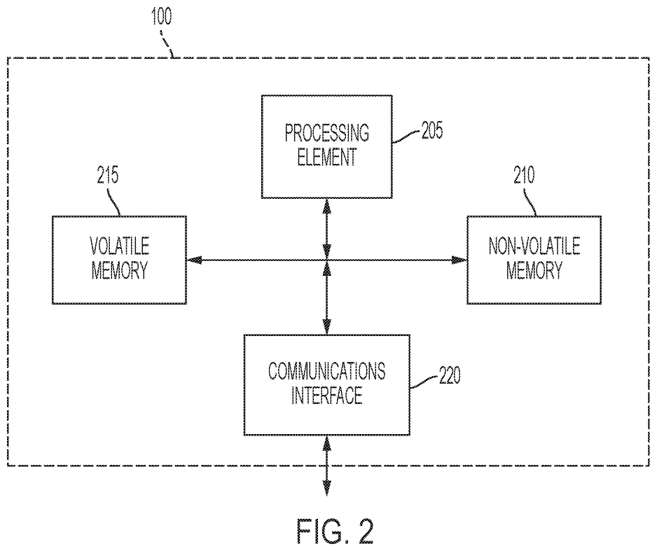

FIG. 2 provides a schematic of a management computing entity 100 according to one embodiment of the present disclosure. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the management computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the management computing entity 100 may communicate with user computing entities 110 and/or a variety of other computing entities.

As shown in FIG. 2, in one embodiment, the management computing entity 100 may include or be in communication with one or more processing elements 205 (also referred to as processors, processing circuitry, and/or similar terms used herein interchangeably) that communicate with other elements within the management computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly. For example, in some embodiments, the processing element 205 may be configured to analyze one or more images.

In one embodiment, the management computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the management computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the management computing entity 100 with the assistance of the processing element 205 and operating system.

As indicated, in one embodiment, the management computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the management computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the management computing entity 100 may include or be in communication with one or more input elements, such as a keyboard input, a mouse input, a touch screen/display input, motion input, movement input, audio input, pointing device input, joystick input, keypad input, and/or the like. The management computing entity 100 may also include or be in communication with one or more output elements (not shown), such as audio output, video output, screen/display output, motion output, movement output, and/or the like.

As will be appreciated, one or more of the management computing entity's 100 components may be located remotely from other management computing entity 100 components, such as in a distributed system. Furthermore, one or more of the components may be combined and additional components performing functions described herein may be included in the management computing entity 100. Thus, the management computing entity 100 can be adapted to accommodate a variety of needs and circumstances. As will be recognized, these architectures and descriptions are provided for exemplary purposes only and are not limiting to the various embodiments.

### Exemplary User Computing Entity

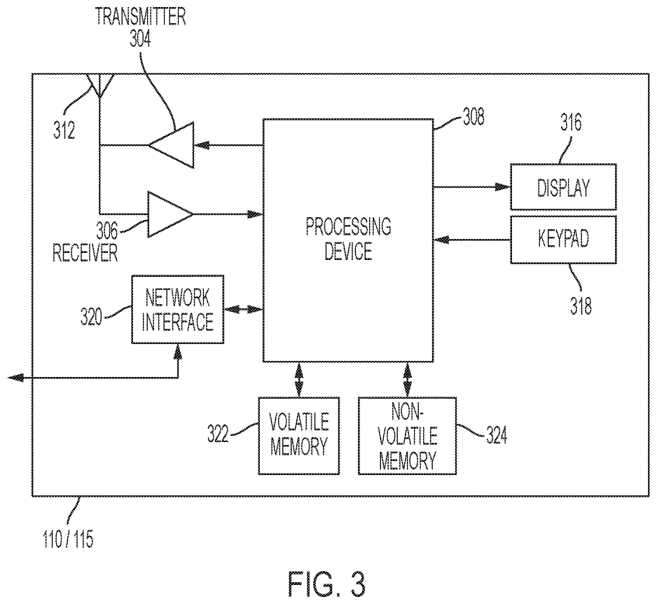

A user may be an individual, a family, a company, an organization, an entity, a department within an organization, a representative of an organization and/or person, and/or the like. To do so, a user may operate a user computing entity 110 that includes one or more components that are functionally similar to those of the management computing entity 100. FIG. 3 provides an illustrative schematic representative of a user computing entity 110 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities 110 can be operated by various parties. As shown in FIG. 3, the user computing entity 110 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the user computing entity 110 may be capable of operating with one or more air interface standards, communication protocols, modulation types, and access types. More particularly, the user computing entity 110 may operate in accordance with any of a number of wireless communication standards and protocols, such as those described above with regard to the management computing entity 100. In a particular embodiment, the user computing entity 110 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 110 may operate in accordance with multiple wired communication standards and protocols, such as those described above with regard to the management computing entity 100 via a network interface 320.

Via these communication standards and protocols, the user computing entity 110 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 110 can also download changes, add-ons, and updates, for instance, to its firmware, software (e.g., including executable instructions, applications, program modules), and operating system.

According to one embodiment, the user computing entity 110 may include location determining aspects, devices, modules, functionalities, and/or similar words used herein interchangeably. For example, the user computing entity 110 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user computing entity's 110 position in connection with a variety of other systems, including cellular towers, Wi-Fi access points, and/or the like. Similarly, the user computing entity 110 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user computing entity 110 may also comprise an IETM viewer (that can include a display 316 coupled to a processing element 308) and/or a viewer (coupled to a processing element 308). For example, the IETM viewer may be a user application, browser, user interface, graphical user interface, and/or similar words used herein interchangeably executing on and/or accessible via the user computing entity 110 to interact with and/or cause display of information from the management computing entity 100, as described herein. The term “viewer” is used generically and is not limited to “viewing.” Rather, the viewer is a multi-purpose digital data viewer capable and/or receiving input and providing output. The viewer can comprise any of a number of devices or interfaces allowing the user computing entity 110 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the user computing entity 110 and may include a full set of alphabetic keys or set of keys that may be activated to provide a full set of alphanumeric keys. In addition to providing input, the viewer can be used, for example, to activate or deactivate certain functions, such as screen savers and/or sleep modes.

The user computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 110. As indicated, this may include a user application that is resident on the entity or accessible through a browser or other IETM viewer for communicating with the management computing entity 100 and/or various other computing entities.

In another embodiment, the user computing entity 110 may include one or more components or functionality that are the same or similar to those of the management computing entity 100, as described in greater detail above. As will be recognized, these architectures and descriptions are provided for exemplary purposes only and are not limiting to the various embodiments.

### Exemplary System Operations

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. Greater or fewer operations may be performed than shown in the figures and described herein. These operations may also be performed in a different order than those described herein.

As described above, the management computing entity 100 and/or user computing entity 110 may be configured for storing technical documentation (e.g., data) in an IETM, providing access to the technical documentation to a user via the IETM, and/or providing functionality to the user accessing the technical documentation via the IETM. In general, the technical documentation is typically made up of volumes of text along with other media objects. In many instances, the technical documentation is arranged to provide the text and/or the media objects on an item. For instance, the item may be a product, machinery, equipment, a system, and/or the like such as, for example, a bicycle or an aircraft.

Accordingly, the technical documentation may provide textual information along with non-textual information (e.g., one or more visual representations) of the item and/or components of the item. Textual information generally includes alphanumeric information and may also include different element types such as graphical features, controls, and/or the like. Non-textual information generally includes media content such as illustrations (e.g., 2D and 3D graphics), video, audio, and/or the like. Although the non-textual information may also include alphanumeric information.

The technical documentation may be provided as digital media in any of a variety of formats, such as JPEG, JFIF, JPEG2000, EXIF, TIFF, RAW, DIV, GIF, BMP, PNG, PPM, MOV, AVI, MP4, MKV, and/or the like. In addition, the technical documentation may be provided in any of a variety of formats, such as DOCX, HTMLS, TXT, PDF, XML, SGML, JSON and/or the like. As noted, the technical documentation may provide textual and non-textual information of various components of the item. For example, various information may be provided with respect to assemblies, sub-assemblies, sub-sub-assemblies, systems, subsystems, sub-subsystems, individual parts, and/or the like associated with the item.

In various embodiments, the technical documentation for the item may be stored and/or provided in accordance with S1000D standards and/or a variety of other standards. According to various embodiments, the management computing entity 100 and/or user computing entity 110 provides functionality in the access and use of the technical documentation provided via the IETM in accordance with user instructions and/or input received from the user via an IETM viewer (e.g., a browser, a window, an application, a graphical user interface, and/or the like).

Accordingly, in particular embodiments, the IETM viewer is accessible from a user computing entity 110 that may or may not be in communication with the management computing entity 100. For example, a user may sign into the management computing entity 100 from the user computing entity 110 or solely into the user computing entity 110 to access technical documentation via the IETM and the management computing entity 100 and/or user computing entity 110 may be configured to recognize any such sign in request, verify the user has permission to access the technical documentation (e.g., by verifying the user's credentials), and present/provide the user with various displays of content for the technical documentation via the IETM viewer (e.g., displayed on display 316).

Further detail is now provided with respect to various functionality provided by embodiments of the present disclosure. As one of ordinary skill in the art will understand in light of this disclosure. The modules now discussed and configured for carrying out various functionality may be invoked, executed, and/or the like by the management computing entity 100, the user computing entity 110, and/or a combination thereof depending on the embodiment.

### Example Vision Tear Inspection Systems, Apparatuses, and Methods

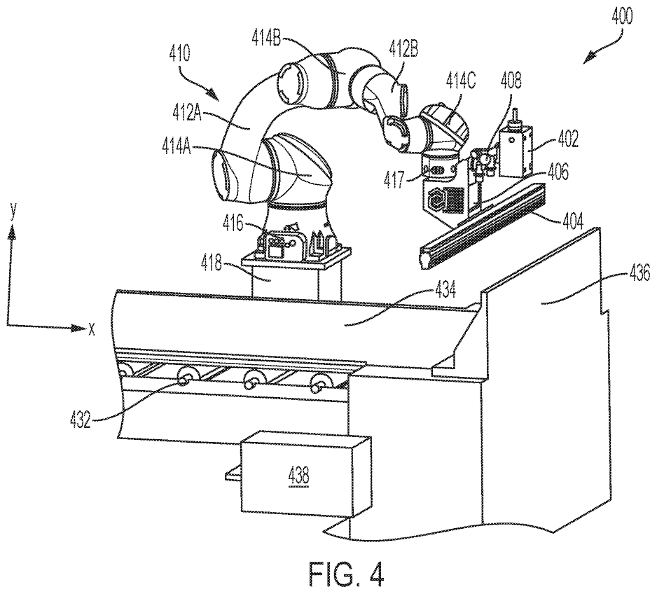

FIGS. 4, 5, 6A, and 6B show angled views of an example tear inspection system 400. In some embodiments, the tear inspection system 400 may be configured to capture high speed imaging of tears or abrasions in a product, such as paper tears during gypsum production. In other embodiments, the system 400 may detect not only tears but also other defects in a product, such as paper defects in gypsum. In further embodiments, the system 400 may distinguish between genuine tears in the product that require halts in production and minor defects that may “self-heal” and not require halts in production. In further embodiments, the system 400 may use line scan technology to detect these tears or other abrasions or defects in a product. The system 400 may include a robotic device or a gantry, either of which may be configured to position and align a lighting device and an imaging device for capturing images of the product on the production line. The system 400 may also include one or more of the control systems and devices previously discussed in this disclosure.

In some embodiments, the system 400 may include an imaging device 402. In some embodiments, the imaging device 402 may be a camera. In some embodiments, the imaging device 402 may be secured in a box or similar structure to prevent, among other things, debris from hitting and potentially damaging the imaging device 402 or misaligning the imaging device 402. In some embodiments, the imaging device 402 may be configured to capture images at high speeds. For example, the imaging device 402 may capture images at a speed of 100 ms per image. In other embodiments, the imaging device 402 may capture images at a speed of 80 ms per image, or other time periods less than 100 ms per images. It will be understood that the imaging device 402 may capture images at varying speeds depending on the objects being produced or the desired manufacturing. In some embodiments, the imaging device 402 may be a Keyence camera.

In some embodiments, the system 400 may include a lighting device 404. In some embodiments, the lighting device 404 may be a line light. In some embodiments, the lighting device 404 may be a high-powered light-emitting diode (LED) light. In other embodiments, the lighting device 404 may emit a light with a length (length herein indicated by the “x” axis in FIGS. 4, 5, 6A, 6B, and 7) of between half an inch and four inches. In further embodiments, the lighting device 404 may emit a light with a width (width herein indicated by the “y” axis in FIGS. 4, 5, 6A, 6B, and 7) of between 24 and 54 inches. It will be understood that the dimensions illuminated by the lighting device 404 may vary depending on the objects being produced or the desired manufacturing. For example, for gypsum board, the lighting device 504 may illuminate a product at a width of 48 inches.

In some embodiments, the system 400 may include bracketry 406 and a three-axis gimbal 408. In some embodiments, the bracketry and the gimbal 406, 408 may be considered a connecting component. In some embodiments, the bracketry 406 may be connected to the lighting device 404. In other embodiments, the lighting device 404 may be fixedly attached to the bracketry 406. In further embodiments, the three-axis gimbal 408 may be operably connected to the imaging device 402. In some embodiments, and as will be described later in this disclosure in greater detail, the bracketry 406 and the gimbal 408 may be configured to position, reposition, align, and realign the imaging device 402 and the lighting device 404. For example, prior to production, the imaging device 402 and the lighting device 404 may be aligned by means of the bracketry and the three-axis gimbal 406, 408 prior to beginning the production cycle. In another example, the bracketry and three-axis gimbal 406, 408 may be repositioned during the production cycle to get the imaging device and lighting device 402, 404 out of the way for the operators to work on the production line.

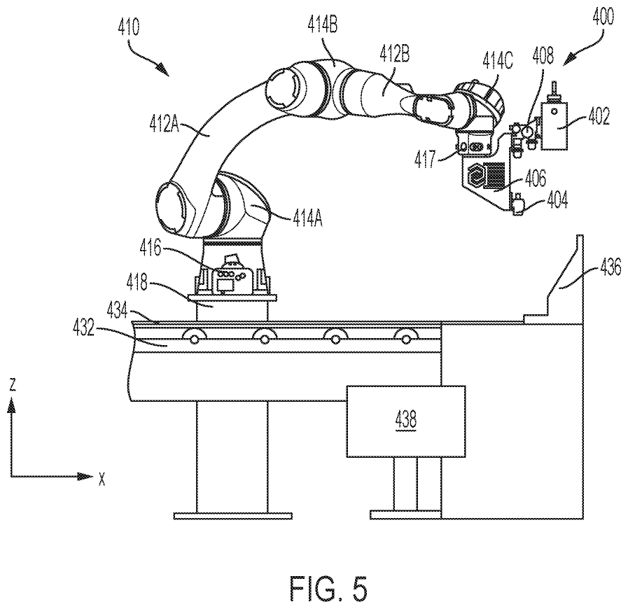

As shown in at least FIGS. 4 and 5, in some embodiments, the system 400 may include a robotic device 410 configured to hold and reposition the imaging device 402, lighting device 404, bracketry 406, and three-axis gimbal 408. In some embodiments, the robotic device 410 may include one or more articulating limbs 412A and 412B, one or more joints 414A, 414B, and 414C, and a base 416. In some embodiments, the robotic device 410 may include an engagement joint 417 that may be configured to hold and be operably connected to the bracketry 406. In some embodiments, the robotic device 410 may be disposed on a pedestal 418. In some embodiments, the robotic device 410 may be positioned adjacent to the production line 432. In other embodiments, the robotic device 410 may be positioned over top of the production line 432. It will be understood that the positioning and orientation of the robotic device 410 may be varied depending on the needs of the operators on the production line 432, or depending on the products being produced on the production line 432.

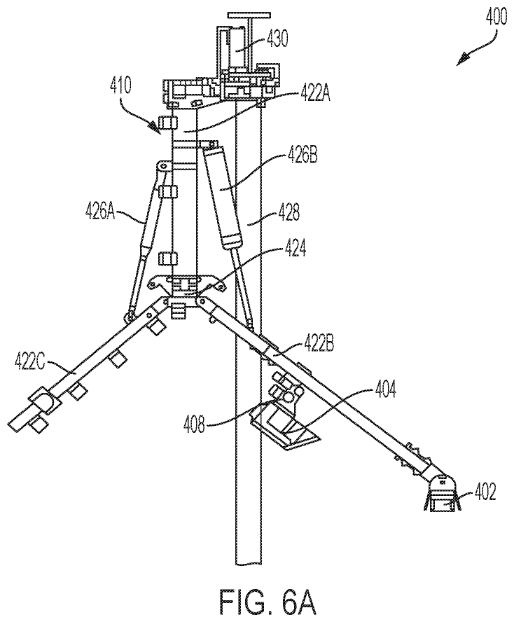

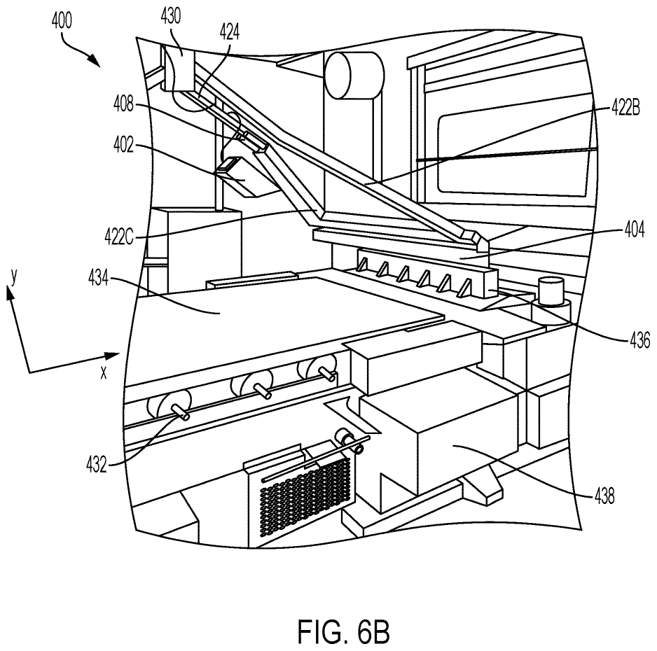

As shown in at least FIGS. 6A and 6B, in some embodiments, the system 400 may include a gantry 420 configured to hold and position one or more of the imaging device 402, lighting device 404, bracketry 406, and three-axis gimbal 408. In some embodiments, the gantry 420 may have a central limb 422A that may be operably connected to a central connection joint 424. In some embodiments, one or more operational limbs 422B, 422C may be connected to the central connection joint 424. In some embodiments, the imaging device 402 and the lighting device 404 may be disposed on one of the operational limbs 422B, 422C. In other embodiments, the imaging device 402 may be disposed on one limb while the lighting device 404 is disposed on another (such as in FIG. 6B). In some embodiments, one or more damping devices 426A, 426B may be connected from the central limb 422A to one or more of the operational limbs 422B, 422C. In some embodiments, the gantry 420 may be connected to a pillar 428. In other embodiments, the gantry 420 may be connected to a rig by means of a connecting beam 430. In some embodiments, this rig may be an I-beam disposed above the production line 432. In some embodiments, the connecting beam 430 may be configured to slide the gantry 420 along the I-beam within, for example, a production environment. This may enable operators to move the gantry 420 out of way of the production line 432 to, among other things, allow the operators to work on the production line 432.

In some embodiments, the system 400 may include a production line 432, which, in other embodiments, may include a plurality of rollers. In some embodiments, a product 434 (such as a gypsum board) may be disposed on the production line 432. In some embodiments, the system 400 may include a forming plate 436 disposed at one end of the production line 432. In some embodiments, the system may include a gearbox 438 disposed adjacent to the production line 432. In some embodiments, the forming plate 436 may be configured to form gypsum board. In some embodiments, the imaging device and lighting device 402, 404 may be aligned to capture images and illuminate, respectively, area of the product right in front of the forming plate 436; that is, images are captured of the product just as it is being formed. This alignment configuration may be seen in at least FIGS. 3, 4, and 6B. In some embodiments, this alignment of the imaging device and lighting device 402, 404 may be maintained throughout the production cycle to illuminate and capture images of the product 434 as it is exiting the forming plate 436. Depending on the product 434 on the production line 432, the alignment position of the imaging device and lighting device 402, 404 with respect to the forming plate 436 may be adjusted. It will be understood that this adjustment and alignment may be performed by the control devices previously discussed in this disclosure. It will further be understood that the alignment may be performed manually by operators.

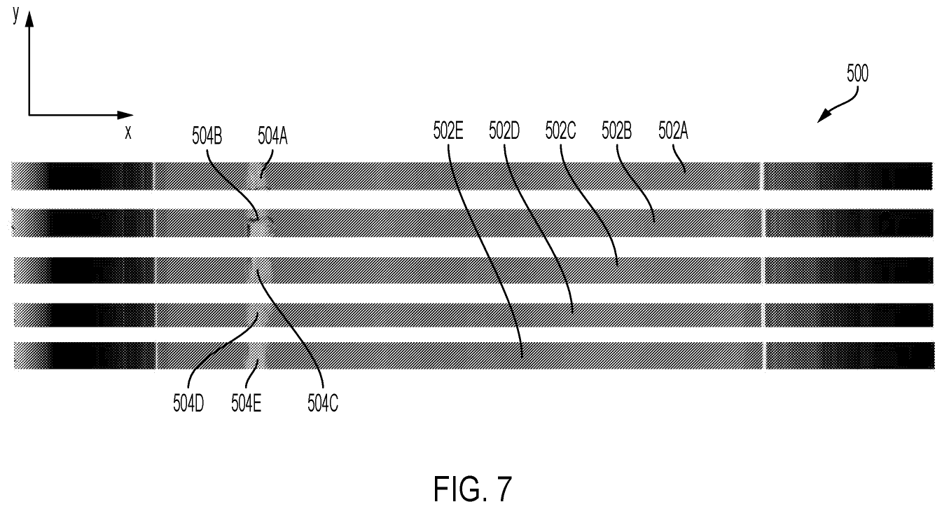

FIG. 7 illustrates example images 500 taken by the example system 400 in accordance with various embodiments of the present disclosure. The images 500 are separated by white space, but it will be understood that this is for visualization only. The edge of the images 500 may be indicated by the vertical white lines. In some embodiments, these images 500 may be taken by the imaging device 402. In some embodiments, these images 500 may be approximately 1 inch thick. It will be understood that the width of the images captures may be greater than or less than 1 inch. In some embodiments, these images may be as wide as the product 434, which may range, in some embodiments, from about 24 to about 54 inches. In other embodiments, the device 402 may take these images in rapid succession, such as with 80 ms between each image capture. It will be understood that the range of time between image capture may be greater than or less than 80 ms. As shown in at least FIG. 7, in some embodiments, the imaging device 402 may capture 5 images 502A, 502B, 502C, 502D, and 502E. In some embodiments, the images 502A-E may be image captures of the product 434 on the production line 432. In some embodiments, the images may be images captured of the rear side of a gypsum board. In some embodiments, the images 502A-E may be gray scaled. In some embodiments, the images may reveal potential tears 504A, 504B, 504C, 504D, and 504E. In some embodiments, these images 500 may be transmitted to the control devices previously discussed in this disclosure. In some embodiments, transmission may occur by means of the communications interfaces 220 and may be stored, in some embodiments, in memory media 210. In some embodiments, these components may be part of the system 400.

In some embodiments, the control devices and systems previously described in this disclosure may be configured to analyze the images 502A-E and the potential tears 504A-E to determine if the potential tears are in fact tears and if production on the production line 432 needs to be halted to address the tears. In some embodiments, this analysis may be performed by the management computing entity 100 and, in some embodiments, by processing element 205. In some embodiments, these components may be part of the system 400. Example analyses of the images 500 will now be described. It will be understood, however, that this analysis is not the only way in which the control devices and systems could operate and that the analysis may vary depending on several factors, such as the products on the production line. In some embodiments, tears or defects may be identified by contrast levels in a gray scale image (indicated by 504A-E on the respective images 502A-E). In other embodiments, once the control device detects the different contrasts (i.e., once it detects a potential tear 504A-E has occurred), the control device triggers an alarm and lifts the forming plate 436 and permits foreign debris to pass through. Production may then be restarted once the tear has been resolved. However, in some embodiments, potential tears 504A-E may not be tears at all, but may be mere defects that will “self-heal,” such that the potential tears do not grow in size on the production line and resolve themselves. In these instances, it may not be desirable to stop production for a tear that will “self-heal.” Hence, in some embodiments, the control devices may be configured to detect for these potential tears that will self-heal. Therefore, in various embodiments, the control device will analyze one or more images 502A-E and one or more potential tears 504A-E and consider whether the potential tears 504A-E are doing one or more of: increasing in size or changing color (i.e., growing darker). In some embodiments, if the control device detects that the potential tears 504A-E are either increasing in size or growing darker, it will signal to the system 400 that a tear has occurred and halt production. However, in other embodiments, if the control device detects that the potential tears 504A-E are not increasing in size or growing darker, it will not signal the system 400 and will allow the potential tears 504A-E to “self-heal.” In some embodiments, the control device may need only two images to make this determination, but in other embodiments the control device may require more images. It will be understood that the level of images to be analyzed by the control device may vary depending on the number of images captured by the imaging device, the control device's capabilities, and the product 432 being produced on the production line 434. In some embodiments, the system 400 may require multiple iterations of scans to ensure that a tear is in fact forming. In at least this way, by requiring multiple scans before determining that there is in fact a tear, the system 400 may avoid “false detection” of natural defects in the paper that may be misidentified as tears.

In some embodiments, the tear inspection system 400 may be configured to interact with other systems on the production line 432. In some embodiments, the system 400 may be linked to other systems, such as an edge forming system or a tape detection sensor. It will be understood that the control systems previously described in this disclosure may interact or be integrated with the control systems for the other systems on the production line 432. For example, in some embodiments, the tear detection system 400 may detect a tear in the product 434, transmit this information to an edge forming system down the production line 432, and the edge forming system may be adjusted accordingly.

An example method 600 of the system 400 will now be described. It will be understood that this method 600 is not the exclusive method of operation for the system 400 but is merely disclosed to further describe various embodiments of the system 400. It will further be understood that, while the method 600 is disclosed with reference to the components of the system 400, it may also be performed with other components and systems capable of performing the disclosed method steps. In some embodiments, the method 600 may include a step 602 of aligning, by a robotic device, the imaging device and lighting device with the forming plate. In other embodiments, the method 600 may include a step 604 of capturing, by means of the imaging device, one or more images of the product on the production line. In further embodiments, the method 600 may include a step 606 of transmitting, to a control device, the one or more images of the product on the production line. In some embodiments, the method 600 may include a step 608 of analyzing, by the control device, the one or more images of the product on the production line to determine if one or tears have occurred. In other embodiments, the method 600 may include a step 610 of, if a tear has occurred, signaling, by the control device, to halt the production line.

### CONCLUSION

Many modifications and other various embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific various embodiments disclosed and that modifications and other various embodiments are intended to be included within the scope of the appended claims. Although specific terms are employed herein, they are used in a generic and descriptive sense only and not for purposes of limitation.

1. A system for detecting product tears, the system comprising:
a lighting device configured to illuminate a portion of a product as it is produced by a forming device on a production line;
an imaging device configured to capture one or more images of the illuminated portion of the product as it is produced by the forming device on the production line; and
a control device configured to store one or more thresholds, wherein the control device is configured to receive the one or more captured images, and
wherein the control device is configured to analyze the one or more captured images and, if at least a portion of one of the one or more captured images exceeds the one or more stored thresholds, send a signal to cease production on the production line.

2. The system of claim 1, wherein the lighting device and the imaging device are aligned such that the one or more images illuminated and captured by the lighting device and the imaging device, respectively, are of the product as it exits the forming device on the production line.

3. The system of claim 1, wherein the system further comprises a connecting component, the connecting component being operably connected to one or more of the lighting device and the imaging device, wherein the connecting component is configured to align the lighting device with the imaging device.

4. The system of claim 1, the system further comprising a robotic device configured to be operably connected to one or more of the lighting device and the imaging device and to position the one or more of the lighting device and the imaging device adjacent to the production line.

5. The system of claim 4, wherein the robotic device is configured to position the one or more of the lighting device and the imaging device above the production line.

6. The system of claim 5, wherein the robotic device is configured to align the lighting device and the imaging device.

7. The system of claim 1, the system further comprising a gantry configured to be operably connected to one or more of the lighting device and the imaging device and to position the one or more of the lighting device and the imaging device above the production line.

8. The system of claim 7, wherein the gantry is operably connected to a rig disposed above the production line, and wherein the gantry is configured to slide along the rig and thereby reposition the gantry and the one or more of the lighting device and the imaging device above the production line.

9. The system of claim 1, wherein the portion of the object that is illuminated by the lighting device comprises a width between 24 and 54 inches and a length between half an inch and four inches.

10. The system of claim 1, wherein the control device is configured to analyze the one or more captured images and, if at least three of the one or more captured images exceed the one or more stored thresholds, send a signal to cease production on the production line.

11. The system of claim 1, wherein the one or more thresholds are selected from a group consisting of the color of the image, the width of the image, and the length of the image.

12. The system of claim 1, wherein the product comprises one or more gypsum boards.

13. The system of claim 1, wherein the lighting device comprises a line light.

14. The system of claim 1, wherein the imaging device is configured to capture at a speed of less than 100 milliseconds the one or more images of the illuminated portion of the product as it is produced by the forming device on the production line.

15. The system of claim 1, wherein the one or more captured images are grayscale at least when they are analyzed by the control device.

16. The system of claim 1, wherein the portion of the one of the one or more captured images comprises a tear in the product.

17. The system of claim 1, wherein the portion of the one of the one or more captured images comprises a defect that will self-heal.

18. The system of claim 1, wherein the control device is configured to refrain from sending a signal to cease production on the line if the one or more thresholds are not exceeded.

19. A method for detecting product tears, the method comprising:
aligning, by a robotic device, an imaging device and a lighting device with a forming plate on a production line;
capturing, by the imaging device, one or more images of a product formed by the forming plate on the production line;
transmitting, to a control device, the one or more images of the product on the production line;
analyzing, by the control device, the one or more images of the product on the production line to determine if one or more tears have occurred; and
if a tear has occurred, signaling, by the control device, to halt the production line.

20. The method of claim 19, the method further comprising, if a tear has not occurred, refraining, by the control device, from signaling to halt the production line.
